(19) United States
(12) Patent Application Publication
(10) Pub. No.: US 2008/0280586 A1
(43) Pub. Date: Nov. 13, 2008

(54) Remote Control with Rf Protocol

(75) Inventor: Teunis Den Ouden, Ovar (PT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,811

(22) PCT Filed: Dec. 5, 2006
(86) PCT No.: PCT/IB06/54602

§ 371 Date: Jun. 10, 2008

(30) Foreign Application Priority Data
Dec. 15, 2005 (EP) 05112255.4

(51) Int. Cl. H04B 1/06

(52) U.S. Cl. 455/352

(57) ABSTRACT

The invention relates to an electronic system (1) comprising a remote control unit (10) and a controlled electronic device (20) which communicate via RF signals and an RF protocol. According to said protocol, data packets to be sent are first extended by a check sum, then extended by information for Forward Error Correction (FEC), and finally subjected to interleaving. The protocol allows a reliable RF communication even in future home environments with many RF interferences.

The invention relates to an electronic system comprising a remote control unit for transmitting binary data packets via an RF protocol to an electronic device. Moreover, the invention relates to a remote control unit, an electronic device, and a method using the RF protocol of the aforementioned system.

Classical remote control systems for consumer electronics use mostly infrared (IR) as the medium to transport data from the remote control to the controlled device. An alternative medium is radio frequency (RF), which is understood here as the part of the electromagnetic spectrum ranging from about 10 kHz to about 100 GHz. An advantage of RF over infrared is that it has a larger range and that it is not blocked by objects like furniture or walls.

From the WO 98/34208 A1, a remote control unit is known which can communicate via IR and RF, thus being able to control both conventional as well as modern electronic devices. To be able to detect errors in the binary data packets sent via RF signals, attachment of a check sum is proposed in that document.

Based on this situation, it was an object of the present invention to provide means for a more efficient and reliable RF communication between a remote control unit and an electronic device.

This object is achieved by an electronic system according to claim 1, a remote control unit according to claim 2, an electronic device according to claim 3, and a method according to claim 4. Preferred embodiments are disclosed in the dependent claims.

According to its first aspect, the invention relates to an electronic system which comprises at least the following components:
A remote control unit for transmitting binary data packets via RF signals.
An electronic device that can be controlled by RF signals from the aforementioned remote control unit.

Furthermore, the remote control unit and the controlled electronic device are adapted to communicate via an RF protocol in which data packets to be sent are sequentially subjected to the following steps:
a) Extension of the data packets by information for error detection.
b) Further extension of the data packets by information for Forward Error Correction (abbreviated “FEC” in the following).
c) Interleaving of the binary symbols of the further extended data packets.

The invention further relates separately to a remote control unit and an electronic device, respectively, which are adapted to be used in an electronic system of the kind described above.

Finally, the invention is related to a method for communicating binary data packets by RF signals from a remote control unit to an electronic device, wherein data packets to be sent are sequentially subjected to steps a), b), and c) listed above.

The electronic system, the remote control unit, the electronic device, and the method have the advantage to provide a highly reliable communication between a remote control unit and a controlled device. This reliability is achieved by a particular combination of error detection, error correction, and error prevention measures contained in steps a) to c). Thus the interleaving in step c) makes the RF protocol robust against bursts of corrupted bits. The FEC in step b) allows with reasonable effort the correction of errors in a limited number of bits and moreover the detection of errors in larger numbers of bits. The FEC is particularly useful in a standard simplex communication between a remote control unit and a controlled device, wherein retransmission of corrupted signals cannot be initiated by the receiver. Finally, the error detection of step a) provides a final check of correctness of the data packets. In summary, the corresponding RF protocol is particularly suited for future home environments, in which interferences from a large number of RF sources are to be expected. At the same time, the RF protocol can be implemented with reasonable effort, which makes it affordable for low cost remote control units.

In the following, optional further developments of the electronic system, the remote control unit, the electronic device and the method are described.

Thus step a) of the RF protocol may particularly comprise the appending of a check sum to the original data packet. As known to a person skilled in the art, a check sum by definition represents the arithmetical sum of predetermined bits of a data packet, possibly restricted to a fixed number of symbols.

If the original data packet to be sent consists of n blocks with k bits each (wherein n, k are natural numbers), the aforementioned check sum may particularly be defined as the sum of all n blocks modulo 2^{k}. Thus the original data packet extended by the check sum will consist of n+1 blocks of k bits each.

According to another embodiment of the invention, step b) of the RF protocol comprises the application of a linear (n, k) coding method to messages consisting of the original data packets extended by error detection information of step a) (wherein n, k are natural numbers). As known to a person skilled in the art, a “linear (n, k) coding method” relates to code words of n symbols, of which k symbols are parity (redundant) symbols. Due to their linearity, such a method may simply be implemented as a matrix multiplication.

In the aforementioned case, the figures n and k may particularly have the values of 8 and 4, respectively. These values provide a reasonable compromise between residual probability of errors and coding effort.

In another embodiment of the invention, step c) of the RF protocol comprises the interleaving of the binary symbols of a message consisting of the original data packet extended by information added in steps a) and b) (i.e. information for error detection and FEC) into m groups of L symbols each, wherein the figures m and L may particularly have the values of 6 and 8, respectively. Neighboring bits in the interleaved message are separated by m positions in the original message. Burst errors affecting several neighboring bits in the interleaved message will therefore be separated by the distance of m symbols after interleaving is inversed during the decoding procedure. Thus, these errors are isolated and may therefore be detectable and correctable due to the provisions of steps a) and b).

The electronic device may in principle be any product that can be controlled by RF signals. In particular, it can be a personal computer, an audio device (CD player, DVD player, tape recorder, radio unit etc.), a video device (VCR, TV, camera, etc.) or a multimedia device.

The remote control unit may be a standard remote control as it is used for example for audio devices or TVs. Moreover, the remote control unit may be a wireless keyboard, a computer mouse or a game device.

These and other aspects of the invention will be apparent from and elucidated with reference to the embodiment(s) described hereinafter. These embodiments will be described by way of example with the help of the accompanying drawings in which:

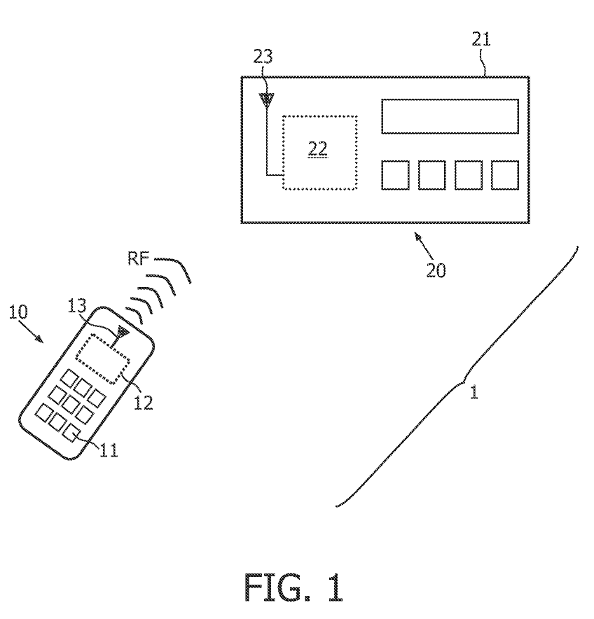

FIG. 1 is a principle sketch of an electronic system according to the present invention;

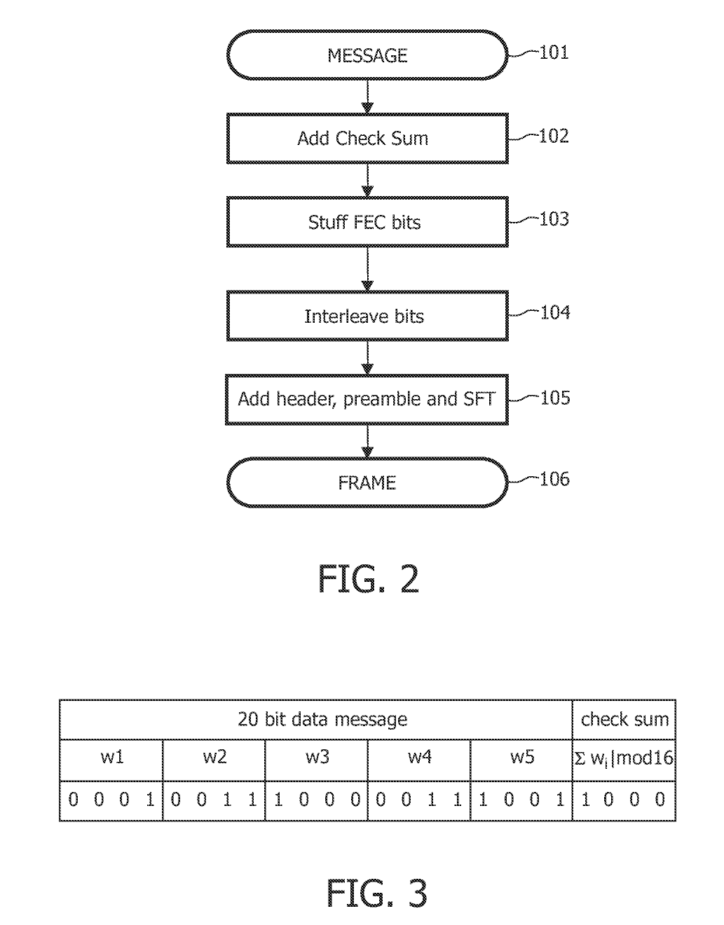

FIG. 2 shows the flow chart of the encoding steps in the remote control unit of FIG. 1;

FIG. 3 shows an exemplary binary data message extended by a check sum;

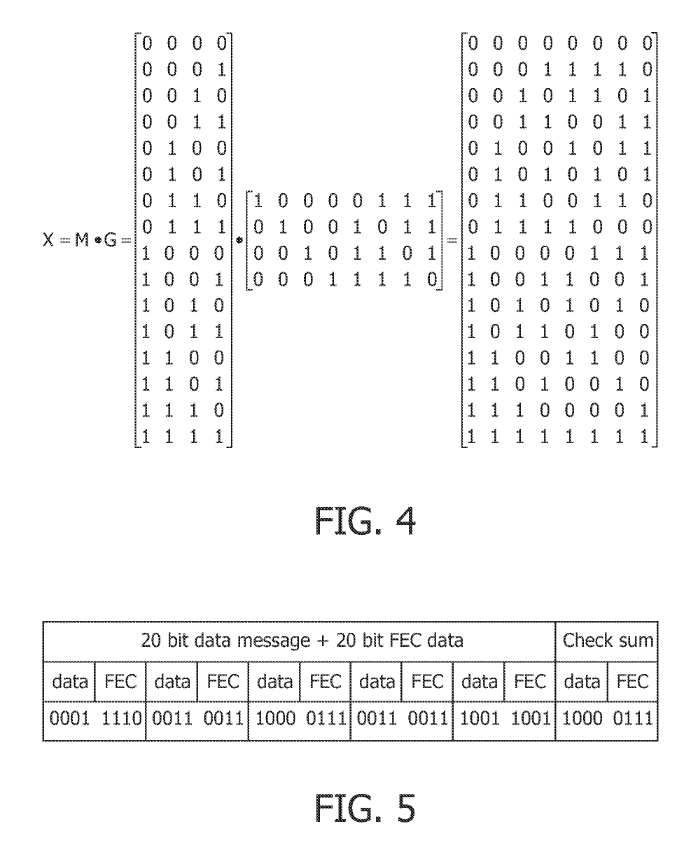

FIG. 4 shows a particular generator matrix for the FEC applied to all possible four-bit messages;

FIG. 5 shows the message obtained by application of the FEC of FIG. 4 to the extended message of FIG. 3;

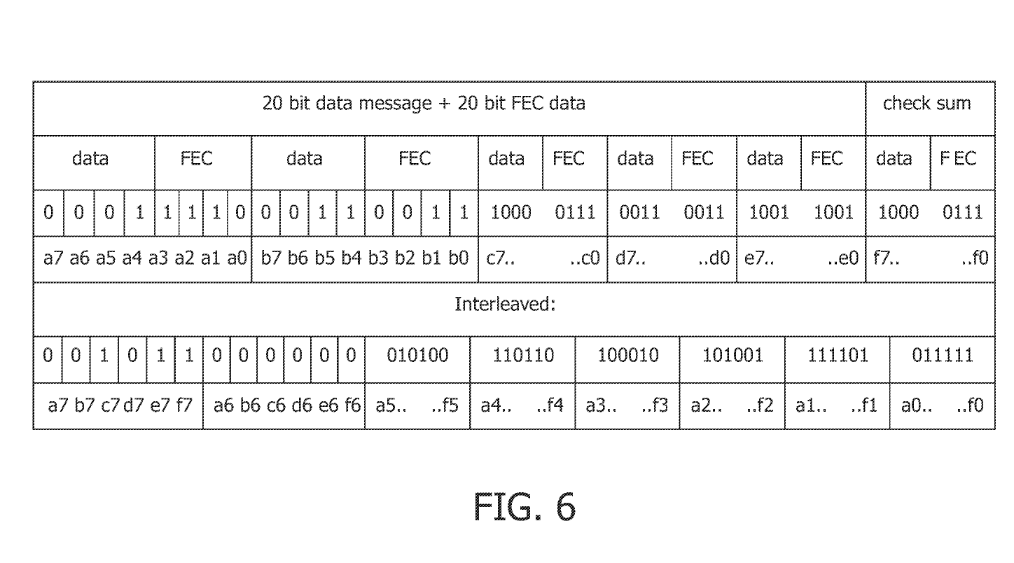

FIG. 6 shows the message of FIG. 5 after the further step of interleaving;

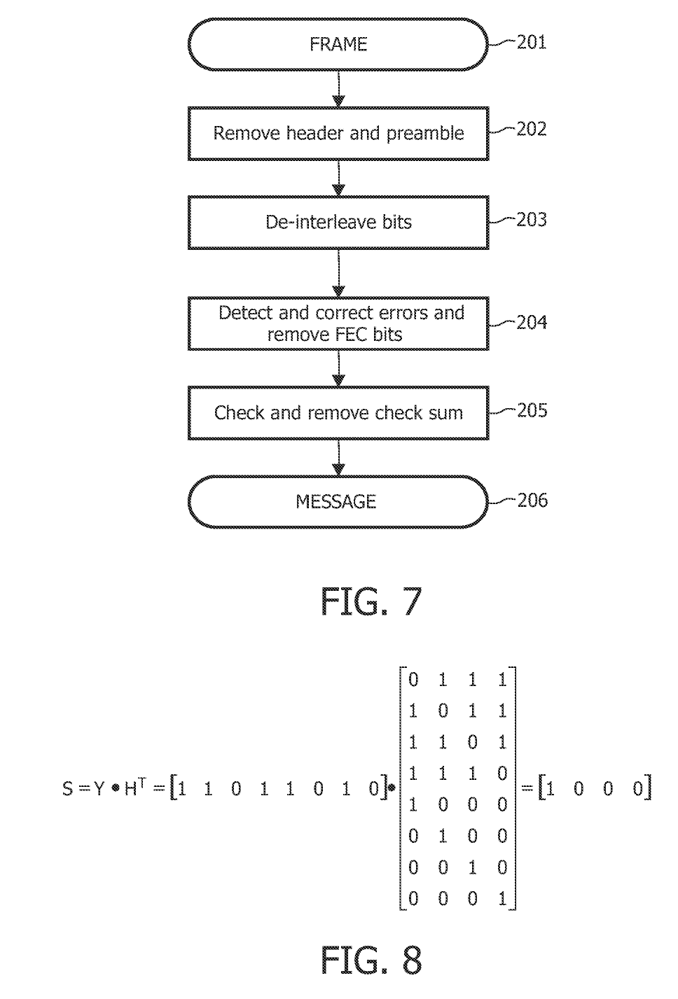

FIG. 7 shows a flow chart of the decoding steps in the controlled electronic device;

FIG. 8 shows an example of the inversion of the FEC;

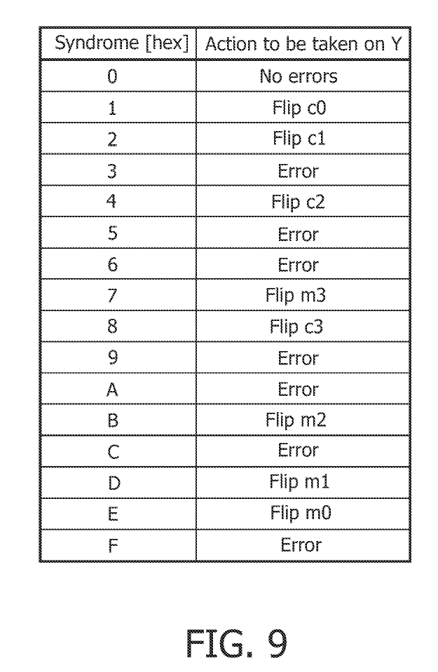

FIG. 9 shows a table with the interpretation of all syndromes that may occur during the inversion of the FEC.

Like reference numbers in the Figures refer to identical or similar components.

FIG. 1 shows schematically the basic components of an electronic system 1 according to the present invention. The system 1 comprises a remote control unit 10, which is depicted as a standard remote control here. The remote control unit 10 comprises keys 11 by which a user can enter data, select control actions and the like. Moreover, it comprises an encoder module 12 which is coupled to an RF antenna 13. The encoder module 12 transforms binary data packets to be sent with a radio frequency (RF) protocol that will be explained in more detail below. The encoded message is then sent via antenna 13 in the form of RF signals.

FIG. 1 further indicates the controlled electronic device 20, which may for example be a CD player. The device 20 comprises an antenna 23 for the reception of the RF signals sent by the remote control unit 10. The received signals are then processed and decoded by a decoder module 22, which reconstructs the original data packets if possible. Other modules of the electronic device 20 may then further process these data according to their particular meaning.

If the remote control unit 10 is in one room and the controlled device 20 in another room, this is no problem for RF signals as they pass through walls (which IR signals would not do). Due to this advantage, RF signals are increasingly applied in home environments. RF communication is however prone to interference from all kind of sources, man-made and natural. As the home environment is changing, there are every time more devices using license free radio frequency bands to communicate with each other. Therefore, license free radio frequency bands are becoming noisier, both from other transmission systems on the same frequency but also from radiated emission of other systems. Methods to overcome the interference have addressed inter alia the radio design and antenna design. The present invention emphasizes on reducing the impact of noise on the RF channel that is used by consumer electronics remote control systems by methods of error detection, error prevention and error correction. The following text describes the implementation of the invention in a simplex RF remote control.

The relevant part of the procedure to transmit and receive a remote control command (message/packet/frame) is the transformation of the original data message into an encoded data message that contains all extra data to facilitate error correction, prevention and detection and the transformation of the encoded message back into the original data message on the receiving side.

The flow chart of FIG. 2 symbolizes how the data in each original message 101 is transformed into a frame 106. This exemplary transformation consists of the following steps:
step 102: adding a 4 bit check sum (CS);
step 103: adding 4 bits of forward error correction (FEC) bits per 4 message bits;
step 104: interleaving those bits in groups of 8 bits;
step 105: preceding the frame by a preamble sequence and a header or start bit and succeeding it by the signal free time (SFT) (header, preamble and signal free time are out of the scope of this invention).

The check sum added in step 102 is used as a final validation of the message on the receiving end. For a data packet defined by the string of words: (w₁, . . . wₖ) the check sum would be w₁+ . . . wₖ. The size of the check sum is sometimes limited by taking the fractional part that still fits in the assigned field: for a binary field of n symbols this would be: (w₁+ . . . wₖ)⊕2ⁿ. There are other methods for error detection, but they go beyond the scope of this invention. In a particular example shown in FIG. 3, the check sum is a value of 4 bits; it is the modulo-16 addition of all nibbles in an exemplary 20 bit data message.

The forward error correction (FEC) of step 103 is added to be able to detect and correct errors in the message as received at the receiving end. There are many methods to achieve error correction on data packets, wherein complex error correction schemes are more powerful in correcting errors than simple schemes, but also demand higher processing power. The relevant variety used here is of the Forward Error Correcting type since most consumer electronics remote control systems use simplex communication. The advantage of FEC is that some errors in received packets may be corrected; this is especially an advantage in a simplex communication system as used in consumer electronics remote controls, since there is no opportunity to use dialog systems like ARQ (automatic repeat request).

Based on the mentioned considerations, this invention uses linear (n,k) codes; code words of n symbols long of which k symbols are parity (redundant) symbols. In particular, the selected FEC scheme is of the Extended Hamming (8,4) type, this is a simple FEC scheme that will not demand a lot of processing power from the low cost micro controllers that are usually used in low cost consumer electronics remote controls. The proposed FEC scheme adds four redundancy bits to each 4 bit of an original message; (8,4) means that there are groups of 8 bits, of which 4 bits are redundant parity bits. This scheme has the ability to correct 1 bit out of each group of 8 bits and also indicate that 1 more bit has an error.

In the considered example the intermediate frame, which is by now the original message plus the check sum bits (FIG. 3), is split up into data nibbles (of 4 bits). Four FEC parity bits are added; one to each data nibble. Extended Hamming (8,4) is used as FEC coding method. This method has a Hamming distance of 4 and therefore can correct one error and also detect one more error in the byte that is formed by the data nibble and the FEC nibble.

A “generator matrix”, G, to create the encoded words from the message words comprises the identity matrix Iₖ and a particularly chosen sub matrix P:G=(Iₖ|P). Multiplying the generator matrix G with the message words gives the encoded words as shown for a particular example of G in FIG. 4. The matrix M comprises all possible instances of a message nibble, and the matrix X all corresponding encoded words.

The encoded words, X, are the combination of M and M·P according to X =(M|M·P). To calculate Xₙ, one could multiply Mₙ with G and find Xₙ (wherein the Xₙ, Mₙ denote the n-th row of X and M, respectively) or one could just use a 16-index lookup table.

FIG. 5 shows the stuffing of the FEC-bits to the message with the check sum of FIG. 3. Adding the FEC-bits changes the intermediate frame length from 6 nibbles into 6 bytes.

The simple FEC as proposed has some weaknesses; one of them is the fact that it can only correct 1 bit per 8 bits of data, that means that burst noise or any noise type that mutilates 2 or more consecutive bits cannot be effectively corrected. Another weakness is that the proposed simple FEC cannot detect all types of errors; it is possible that the word of 8 bits has so many errors that it resembles another, valid, code word; in that case a code word will be designated “correct” while it actually is not.

Instead of using a more powerful FEC scheme, the proposal here is to use other methods to do away with the weaknesses of the simple FEC. To combat burst noise it is particularly proposed to use the interleaving of step 104. The interleaving shuffles all symbols in a data packet so that all first symbols of each word are put together, then all second symbols, etc. For symbols with the following notation: x_{n,m} the original data packet (w₁, . . . wₖ) could be written as: (x_{1,1}, x_{1,2}, . . . x_{1,m}, x_{2,1}, x_{2,2}, . . . x_{2,m}, . . , x_{k,1}, x_{k,2}, . . . x_{k,m}) with k the number of words in the packet and m the number of symbols per word. The bit shuffle with interleaving will change this packet into: (x_{1,1}, x_{2,1}, . . . x_{k,1}, x_{1,2}, x_{2,2}, . . . x_{k,2}, . . . x_{1,m}, x_{2,m}, . . . x_{k,m}).

In the considered example, the whole intermediate frame of FIG. 5 will be interleaved in eight groups. The intermediate frame is split into eight equal length groups of bits, the frame is then rebuilt by putting the first (MSB) bit of all bytes at the beginning of the frame, then all the second bits of all groups, etc. until the eighth bit (LSB) of all groups. The result of this procedure is illustrated in FIG. 6. Interleaving all bits results in a string where the specific fields are not recognizable anymore.

FIG. 7 illustrates the processing that has to be performed on the intermediate frame 201 after transmission of the encoded data packet and its reception by the controlled device 20. This processing consists of the following steps:
step 202: removing header and preamble;
step 203: de-interleaving of bits;
step 204: detecting and correcting errors and removing FEC bits;
step 205: checking and removing check sum;
step 206: passing on the decoded message.

These relevant steps will now be described in more detail with reference to the numerical example considered above.

In the step 203 of de-interleaving, the frame first contains a multiple number of 8 bits: frame length=n×8. The frame must be de-interleaved in eight groups of n bits. The first n bits in the frame form the most significant bit (MSB or bit7) of each byte in the de-interleaved intermediate frame, the next n bits form bit6 of each byte and so on. The result of this process corresponds just to the step back from the last two lines of FIG. 7 to the lines above them (but note that due to interferences during transmission, the actual values of the bits may have changed in an unknown manner!).

In the Forward Error Correction encoding method described above, for each four bits of data four parity bits were added. Each of these groups of eight bits should be decoded separately. On the receiver end, syndrome decoding is used to detect and correct eventual errors. Syndrome decoding requires a “parity check matrix”. The parity check matrix, H, is derived from the “generator matrix”, G. G =(Iₖ|P) and H=(P^{T}|I_{q}). The syndrome, S, indicates if there are errors in the byte. If the error is a single bit that is flipped, then the syndrome indicates which bit was flipped. The syndrome is calculated by multiplying the received code word, Y, with the transpose of H: S=Y·H^{T}. FIG. 8 shows this for the example of the received code word Y=[1 1 0 1 1 0 1 0]. The code word Y is the result of the transmitted code word X plus eventual errors gained during transmission, therefore: Y=(M|C) or Y=[m3, m2, m1, m0, c3, c2, c1, c0]. Note that the high nibble is the real data and the low nibble is the parity bits.

The table of FIG. 9 describes the action that should be taken on Y for each syndrome S, wherein the table mentions three types of action:
“No errors” means that Y is correct.
“Flip yₙ” means that this bit should be flipped and then the byte is corrected. Thus c3 has to be flipped in the example of FIG. 8.
“Error” means that there are errors detected in Y, but the FEC method could not correct them. This word must be rejected and as a result the whole frame must be rejected.

Instead of calculating the syndrome it is also possible to create a 256 index lookup table with the received word, Y, as input and the data nibble, M, as output.

This error correction method only corrects single bit errors and it is also able to detect received words with 2, 4 and 6 bit errors. Words with 3, 5 and 7 bit error will be wrongly corrected as if they only had 1 bit error. Words with all bits flipped (8 bit errors) will be wrongly detected as correct (zero bit errors), no correction required. These types of errors are likely (but not always) caught by the overall check sum.

After correcting the detected errors and validating the corrected code words, the check sum evaluated in step 205 will give the final validation of the entire message. The frame must be rejected when the check sum is not correct; it means that there are still errors in the message, even after the correction attempt with the FEC bits. As already described above, the check sum is the modulo-16 addition of all nibbles in the message. In this case all nibbles except for the last one should be added. The calculated check sum must be compared with the last four bits of the intermediate frame; they must be identical.

Adding all nibble save the last one yields for example: Modulo-16(0001b+0011b+1000b+0011b+1001b)=1000b. If this is equal to the received check sum, the intermediate frame is correct. The resulting message is then obtained after removal of the CS.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An electronic system (1), comprising a remote control unit (10) for transmitting binary data packets by RF signals; an electronic device (20) that can be controlled by RF signals from the remote control unit (10); wherein the remote control unit (10) and the controlled device (20) are adapted to communicate via an RF protocol in which data packets to be sent are sequentially subjected to the following steps: a) extension of the data packets by information for error detection; b) further extension of the data packets by information for Forward Error Correction (FEC); c) interleaving of binary symbols.

2. A remote control unit (10) for transmitting binary data packets by RF signals to an electronic device (20), wherein the remote control unit (10) is adapted to communicate via an RF protocol in which data packets to be sent are sequentially subjected to the following steps: a) extension of the data packets by information for error detection; b) further extension of the data packets by information for Forward Error Correction (FEC); c) interleaving of binary symbols.

3. An electronic device (20) that can be controlled by data packets sent by a remote control unit (10) by RF signals and that is adapted to communicate via an RF protocol in which data packets to be sent are sequentially subjected to the following steps: a) extension of the data packets by information for error detection; b) further extension of the data packets by information for Forward Error Correction (FEC); c) interleaving of binary symbols.

4. A method for communicating binary data packets via RF signals and an RF protocol from a remote control unit (10) to an electronic device (20), wherein data packets to be sent are sequentially subjected to the following steps: I a) extension of the data packets by information for error detection; b) further extension of the data packets by information for Forward Error Correction (FEC); c) interleaving of binary symbols.

5. The electronic system (1), the remote control unit (10), the electronic device (20), and/or the method according to claim 1, wherein step a) comprises appending a check sum.

6. The electronic system (1), the remote control unit (10), the electronic device (20), and/or the method according to claim 5, wherein, for a data packet of n blocks with k bits each, the check sum is calculated as the sum of all blocks modulo 2^{k}.

7. The electronic system (1), the remote control unit (10), the electronic device (20), and/or the method according to claim 1, wherein step b) comprises the application of a linear (n, k) coding method to the data packets extended by error detection information.

8. The electronic system (1), the remote control unit (10), the electronic device (20), and/or the method according to claim 7, wherein n equals 8 and k equals 4.

9. The electronic system (1), the remote control unit (10), the electronic device (20), and/or the method according to claim 1, wherein step c) comprises the interleaving of the binary symbols of the data packet extended by information added in steps a) and b) into m groups of L symbols each.

10. The electronic system (1), the remote control unit (10), the electronic device (20), and/or the method according to claim 9, wherein m equals 6 and L equals 8.

11. The electronic system (1), the remote control unit (10), the electronic device (20), and/or the method according to claim 1, wherein the electronic device is selected from the group consisting of a personal computer, an audio device (20), a video device, and a multimedia device.

12. The electronic system (1), the remote control unit (10), the electronic device (20), and/or the method according to claim 1, wherein the remote control unit (10) is selected from the group consisting of a standard remote control (10), a wireless keyboard, a computer mouse, and a game device.
